(19) United States
(12) Patent Application Publication
(10) Pub. No.: US 2026/0219203 A1
(43) Pub. Date: Jul. 30, 2026

(54) DEVICE FOR DETERMINING OPTICAL PROPERTIES OF AN OPTICALLY TRANSPARENT SUBSTRATE, AND COATING SYSTEM

(71) Applicant: Bühler Alzenau GmbH, Alzenau (DE)

(72) Inventor: Ralf SPERLING, Leipzig (DE)

(21) Appl. No.: 19/146,003

(22) PCT Filed: Jan. 11, 2024
(86) PCT No.: PCT/EP2024/050578

§ 371 Date: Jul. 7, 2025

(30) Foreign Application Priority Data
Jan. 11, 2023 (EP) 23151188.2

(51) Int. Cl. G01N 21/896

(52) U.S. Cl. CPC G01N 21/896

(57) ABSTRACT

A device for determining optical properties of an optically transparent substrate which is provided with a substrate coating on a first side has a first operating mode and a second operating mode, wherein, in the first operating mode, a first emission unit is active and a second emission unit is inactive and, in the second operating mode, the first emission unit is inactive and the second emission unit is active, so that electromagnetic radiation reflected and transmitted in the operating modes can be detected by means of a first detector unit and, respectively, a second detector unit.

Further indicated is a coating system.

### FIELD OF THE INVENTION

The invention relates to a device for determining optical properties of an optically transparent substrate and to a coating system for manufacturing an optically transparent substrate.

### BACKGROUND

In the production of optically transparent substrates, for example for building glazing and solar modules, coatings are usually applied to the substrate in order to create a desired property profile of the coated substrate, for example with regard to transmission properties or thermal insulation. In this context, it is of great importance to be able to reliably determine the quality and the optical behavior actually achieved of the coated substrate.

In this context, devices are known in which the coated substrate is examined by means of a measuring unit that is configured to emit electromagnetic radiation toward the substrate. To this end, the measuring unit has an emission unit that is oriented perpendicular to the surface of the substrate so that the latter can be irradiated with electromagnetic radiation which thus impinges perpendicularly on the substrate. Detector units associated with the emission unit can be used to measure the transmission and reflection of the electromagnetic radiation and to draw conclusions about the quality of the coated substrate.

A drawback of the known solutions is, among others, that they cannot measure transmission and reflection on the coated substrate simultaneously. This prolongs the necessary measurement times and is a disadvantage in particular in coating systems in which the substrate is traversed along a processing direction and a measurement therefore has to be carried out on the moving substrate. The measurement offset in time and the moving substrate result in a comparatively large measuring area, which makes a precise determination of the properties of the substrate more difficult.

The object of the invention is to provide a device that allows optical properties of an optically transparent substrate to be determined reliably and precisely.

The object is achieved according to the invention by a device for determining optical properties of an optically transparent substrate that is provided with a substrate coating on one side. The device includes a first measuring unit and a second measuring unit, the first measuring unit being assigned to the first side of the substrate and the second measuring unit being assigned to a second side of the substrate opposite to the first side. The first measuring unit includes a first emission unit for irradiating a measuring area of the substrate with directed electromagnetic radiation and a first detector unit. The second measuring unit includes at least a second emission unit for irradiating the measuring area of the substrate with directed electromagnetic radiation and at least a second detector unit. The device has a first operating mode and a second operating mode, wherein, in the first operating mode, the first emission unit is active and the second emission unit is inactive and, in the second operating mode, the first emission unit is inactive and the second emission unit is active, so that, in the first operating mode, the electromagnetic radiation reflected by the substrate coating in the measuring area can be detected in the first detector unit and the electromagnetic radiation transmitted by the substrate in the measuring area can be detected in the second detector unit, and, in the second operating mode, the electromagnetic radiation transmitted by the substrate in the measuring area can be detected in the second detector unit.

### SUMMARY

The invention is based on the fundamental idea of using the same measuring area for determining different parameters of the coated optically transparent substrate which permit conclusions to be drawn about the quality of the substrate inclusive of the substrate coating applied to the substrate. The device according to the invention is designed here such that, in the first operating mode, both the reflection caused by the substrate coating, that is, the reflection associated with the first side of the substrate, and the transmission through the substrate can be measured at the same point in time. In other words, the electromagnetic radiation emitted by the first emission unit, after acting on the coated substrate, interacts with both the first detector unit, which is assigned to the first side of the substrate, and the second detector unit, which is assigned to the second side of the substrate. In this way, the measurement period can be reduced and the size of the measuring area can be minimized, irrespective of whether the substrate remains in position or is moved during the measurement.

At the same time, different emission units are provided which can be employed to determine different optical properties of the coated substrate in the same measuring area, wherein the respective measuring conditions are influenced by coatings applied to the first side and/or to the second side of the substrate.

It should be appreciated that the substrate coating on the first side may only partially cover the first side. Moreover, the second side may also be provided with a substrate coating, wherein the substrate coatings associated with the first side and the second side may be the same or different. The substrate coating may further comprise one or more coating layers. It is only decisive that the coatings applied to the optically transparent substrate result in a coated substrate that continues to be optically transparent.

According to the invention, the first emission unit and the second emission unit emit directed electromagnetic radiation. In this connection, the term “directed electromagnetic radiation” means that the electromagnetic radiation is free of scattered light components, apart from inevitable scattered light components from the surroundings of the measuring area. This allows any sources of error in the measurement data obtained by means of the detector units to be minimized and therefore the quality in determining the optical properties of the substrate to be optimized.

In other words, directed electromagnetic radiation is not diffuse light, so that the first emission unit and the second emission unit are not diffuse emission units.

The first emission unit and/or the second emission unit may be arranged in relation to the first side and, respectively, to the second side of the substrate such that the electromagnetic radiation emitted has a first and, respectively, a second emission angle in the range of 3 to 10° relative to the normal of the first side and, respectively, the second side of the substrate, for example a first and/or second emission angle of 8°. In other words, in this configuration, a certain angular offset of the respective emission unit relative to the surface of the coated substrate is selected which enables simultaneous measurement of reflection and transmission and furthermore ensures that the two measurements are made in the same measuring area.

The angular tolerance of the first and/or second emission angle may be defined over a tolerance zone that is fixed as a function of the substrate thickness and the refractive index of the substrate. For example, the angular tolerance is ±1.5° for a substrate thickness of no more than 30 mm and a refractive index of the substrate of up to 1.6.

Preferably, the first emission unit, the second emission unit, the first detector unit, and the second detector unit are arranged in relation to each other such that a first connecting line extending from the first emission unit toward the second detector unit intersects a second connecting line in the measuring area of the substrate which extends from the second emission unit toward the first detector unit.

The first connecting line and the second connecting line thus essentially correspond to the transmission beam path of the directed electromagnetic radiation emitted by the respective emission unit.

Any parallel misalignment of the transmission beam path caused by refraction effects in the substrate remains disregarded with respect to the first and/or second connecting line, as this can be compensated for by the arrangement of the first detector unit and the second detector unit within the respective measuring units and can therefore be tolerated.

The first detector unit and/or the second detector unit may comprise a VIS spectrometer and/or a NIR spectrometer. In this way, the respective detector unit may be configured to detect electromagnetic radiation in the visible range of the light spectrum and of the near infrared range. In these wavelength ranges, it is of particular importance to ascertain the properties of the optically transparent substrate in order to check their suitability for the intended purpose of use. Detection using a VIS spectrometer permits, for example, the determination of the optical appearance that the coated substrate creates in the human eye, such as, e.g., the determination of a color impression. A NIR spectrometer can be used to obtain information on the thermal behavior of the coated substrate.

The first detector unit and/or the second detector unit may comprise a sensor element by means of which the electromagnetic radiation reaching the respective detector unit from the substrate can be detected, wherein in particular an intensity distribution can be determined as a function of the wavelength of the impinging electromagnetic radiation.

The sensor element may comprise a homogenization device, by means of which the electromagnetic radiation impinging on the sensor element can be homogenized.

The homogenized electromagnetic radiation can then be detected in a sensor of the sensor element.

The homogenization device includes, for example, a collector and a homogenizer connected downstream of the collector along the beam path, the collector and the homogenizer being arranged in relation to each other such that the inlet opening of the homogenizer coincides with the focal point of the collector. In this way, the size of the inlet opening of the homogenizer can be minimized in order to further reduce influences from scattered light. In other words, the angular tolerance of the respective detector unit, i.e. the angular range in which electromagnetic radiation coming from the substrate can contribute to the detected signal, can be set purely through the size of the inlet opening.

The homogenization device, in particular the homogenizer thereof, has an outlet opening through which the homogenized electromagnetic radiation can leave the homogenization device and reach the sensor of the sensor element, which is ultimately used for detection.

In order to further increase the measuring speed of the device, the first emission unit and/or the second emission unit may be assigned a switching element by means of which a source of electromagnetic radiation can be connected in order to actively switch the first emission unit or the second emission unit. In particular, the switching element may be integrated in the respective emission unit. Owing to this configuration, the source of electromagnetic radiation itself need not be switched on or off when the device changes from the first operating mode to the second operating mode. Instead, the time offset that has to be observed when changing the operating modes of the device can be selected merely using the switching time of the switching element employed.

Preferably, the switching element has a switching time of 30 ms or less, in particular 10 ms or less. Switching elements having a suitable switching time are known. The switching element may be a fiberswitch, for example.

Fiberswitches, also called fiber switches, distinguish themselves by a particularly short switching time in combination with a high number of cycles. fiberswitches have one or more piezoelectric actuator(s). The respective piezoelectric actuator establishes a connection between fiber ends of the fiberswitch or disconnects them. The fiber ends to be connected or disconnected are each assigned to a connection point or an output of the fiberswitch.

The fiberswitch may include one or more connection point(s), to which the source of electromagnetic radiation is connected. In particular, the device may include a plurality of sources of electromagnetic radiation, each of the plurality of sources of electromagnetic radiation being connected to a different connection point.

Moreover, the fiberswitch may include one or more outputs connected to that emission unit to which the fiberswitch is assigned.

Of course, the number of connection points and outputs of the fiberswitch may also differ, for example, it may have a plurality of connection points and a single output.

A fiberswitch furthermore exhibits a high attenuation between the connection channels resulting from connecting the respective fiber ends, so that the respective connection established is unaffected or at least as little affected as possible by the other available fibers of the fiberswitch.

It should be appreciated that the fiberswitch needs to be at least partially transparent to that portion of the electromagnetic radiation that is generated by the source or sources of electromagnetic radiation and that is to be emitted by the respectively associated emission unit. For example, the fiberswitch has a working wavelength range of from 250 to 2500 nm, in particular of from 275 to 2100 nm.

The switching frequency of the fiberswitch is, in particular, in the range of from 0.005 to 30 Hz, for example from 0.01 to 20 Hz. This allows the fiberswitch to perform a switching operation again after only a short time offset. The measuring area may have a length of 30 mm or less, in particular 20 mm or less, for example 12 mm or less. This allows the optical properties of the substrate to be determined with particular precision, since the measurement data obtained in the measurements are representative of a comparatively small area of the substrate, which allows errors due to averaged measurement data to be minimized or ruled out. A measuring area of such lengths can be realized by the configuration according to the invention and the adjustment according to the invention between the first emission unit, the first detector unit, the second emission unit and the second detector unit.

The geometric shape of the measuring area on the surface of the substrate, that is, its cross-section, is not restricted in any way. The measuring area may, for example, be circular, oval, square or rectangular. The length of the measuring area always refers to the extent of the measuring area along the direction in which the measuring area is largest.

In one variant, at least one of the first measuring unit and the second measuring unit has a third emission unit for irradiating the measuring area of the substrate with directed electromagnetic radiation and a third detector unit assigned to the third emission unit. The third emission unit is arranged in relation to the first side and/or to the second side of the substrate such that the electromagnetic radiation emitted has a third emission angle relative to the normal of the first side and, respectively, the second side of the substrate.

The third emission angle may be selected flexibly, depending on which property of the coated substrate is to be determined based on the measurement data obtained in the third detector unit.

In particular, the third emission angle is in the range of 45 to 65°.

The optical properties of a coated substrate may differ significantly depending on the angle at which the substrate is viewed. The third emission unit allows the appearance of the substrate to be reliably determined even at a comparatively steep angle relative to the respective surface of the substrate. In particular, in this way the color of the optical substrate on the first side and/or the second side can be determined.

In addition, it can be checked in this way that the coated substrate does not feature any so-called “flip-flop” effects. This is understood to mean that the optical impression that the coated substrate evokes in an observer, in particular the color impression, changes considerably and/or abruptly when there is a comparatively small change in the viewing angle.

It will be appreciated that the third emission unit may be assigned only to the first side, in particular as part of the first measuring unit, or may be assigned only to the second side, in particular as part of the second measuring unit. Also, a third emission unit may be integrated both in the first measuring unit and in the second measuring unit.

To allow an optimum measurement depending on the application, the third emission unit may be adjustable in steps or continuously. In this way, the third emission unit can be used to determine the color impression for different viewing angles.

The point in time at which the third emission unit is active can be selected flexibly. For example, the third emission unit can be active in the first and/or second operating modes. Due to the fact that the third emission angle deviates (greatly) from the first emission angle and from the second emission angle, for example by more than 40°, the electromagnetic radiation emitted by the first or second emission unit and the third emission unit is not, or only insignificantly, influenced.

In particular, the electromagnetic radiation has a wavelength in the range from 350 to 2500 nm, for example from 350 to 1600 nm, preferably from 350 to 1200 nm and more preferably from 380 to 1000 nm. At wavelengths below 350 nm, UV properties of the coated substrate would already be measured, which do not play a role in the impression that the coated substrate creates when the optical substrate is viewed with the human eye. Wavelengths with a wavelength of more than 2500 nm are technically difficult to visualize. In addition, measurements with wavelengths of over 2500 nm may result in larger ranges of error due to influences of ambient heat.

Furthermore, at least one measuring head may be provided which includes the first measuring unit and/or the second measuring unit, wherein the measuring head is movable along the substrate.

In this way, the measurement of the optical properties of the coated substrate can be carried out at different points of the coated substrate. In addition, the measuring head can follow the substrate if the latter is moved within the device, so that as small a measuring area as possible is achieved in this case as well.

The device may have a transport device by means of which the substrate can be moved along a processing direction, in particular wherein the substrate can be moved along the processing direction at a speed of several meters per minute. For example, the speed at which the substrate can be moved along the processing direction is in the range of 9 to 25 m/min. In this way, the throughput of examined coated substrates of the device according to the invention can be increased and the handling of the coated substrate within the device can be facilitated.

Preferably, the transport device is combined with the movable measuring head described above, wherein the movement of the measuring head is coordinated with the movement of the substrate.

In particular, the measuring head has a travel speed that is equal to or higher than the speed at which the substrate is moved along the processing direction. For example, the speed of the measuring head is up to 800 mm/s, preferably up to 600 mm/s. It should be appreciated, however, that the travel speed of the measuring head only needs to be adapted to the respective measuring method carried out.

Preferably, the device is configured to determine the optical properties of the substrate in a plurality of measuring areas, wherein for each of the measuring areas at least one measurement is performed in the first operating mode of the device and one measurement is performed in the second operating mode of the device. In other words, the device is configured to screen or scan the coated substrate. In this way, property profiles of the coated substrate can be ascertained over the extent thereof, from which it can be determined how uniform or consistent the coated substrate is across the various measuring areas.

The measuring head may be movable both along the direction of transport of the substrate and along a transverse direction, the transverse direction being perpendicular to the direction of transport. In this way, the optical properties of the substrate can be determined not only along a previously defined line that is parallel to the direction of transport, but also distributed across the substrate. In other words, the measuring area can be freely selected on the substrate.

Since the substrate can be moved along the direction of transport, it may be sufficient to design the measuring head to be movable only in the direction of transport and the transverse direction, that is, only along two directions of movement that are perpendicular to each other. This simplifies the design and thus the costs of the measuring head and the entire device.

In such a configuration, for example, a plurality of measuring areas of the substrate which are measured one after the other in time can be measured along a measuring line which extends obliquely to the transport and transverse directions and which results from a combination of the movement of the substrate along the direction of transport and the movement of the measuring head, which is moved along the transverse direction.

It is, of course, also possible for the measuring head to be movable in any desired spatial directions in order to allow an even more flexible selection of measuring areas to be measured in succession.

In addition, the device may include a unit for performing a measurement of a sheet resistance of the substrate, in particular for performing an eddy current measurement in the measuring area of the substrate. The sheet resistance can be used to examine the properties of the substrate using a complementary method of determining the optical properties in order to identify further parameters of the coated substrate and/or to check the information obtained by means of the detector units. For example, using the eddy current measurement, conclusions can be drawn about the crystal structure of the substrate and/or the substrate coating.

The object of the invention is further achieved by a coating system for manufacturing an optically transparent substrate having a substrate coating applied to a first side of the substrate, which includes a device for determining optical properties of the optically transparent substrate as described above.

The properties and features of the device according to the invention apply correspondingly to the coating system according to the invention and vice versa, and reference is made to the discussions above.

The device for determining optical properties may directly adjoin a coating module of the coating system or may be spatially separate from it.

In one variant, the device for determining optical properties is integrated in the coating system in such a way that the measurement of the optical properties of the optically transparent substrate is examined already during the coating process. For example, the measuring area is selected in a part of the substrate that has already been coated, while a further part of the substrate is being coated upstream along a processing direction of the coating system. This variant allows the coating process to be adjusted on the basis of the optical properties determined.

In an alternative and preferred variant, the device for determining optical properties is a separate system module of the coating system in order not to influence the device for determining optical properties by further modules of the coating system. In other words, the device according to the invention is used in particular as an “ex-situ” measuring device. In addition, such a configuration allows the manufacture of the coated substrate to be separated in terms of time and/or space from the determination of the optical properties of the coated substrate, as a result of which the flexibility in the method of manufacturing the coated substrate is increased.

### BRIEF DESCRIPTION OF THE DRAWINGS

Further features and characteristics of the invention will be apparent from the following description of exemplary embodiments, which should not be construed in a limiting sense, and from the drawings to which reference is made and in which:

FIG. 1 shows a coating system according to the invention;

FIG. 2 shows a device according to the invention for determining optical properties as is employed in the coating system according to FIG. 1;

FIG. 3 shows the device from FIG. 2 in a first operating mode;

FIG. 4 shows the device from FIG. 2 in a second operating mode;

FIG. 5 shows a further embodiment of the device according to the invention analogous to FIG. 2; and

FIG. 6 shows a schematic illustration of selected parts of a detection unit of the device from FIG. 2.

### DETAILED DESCRIPTION

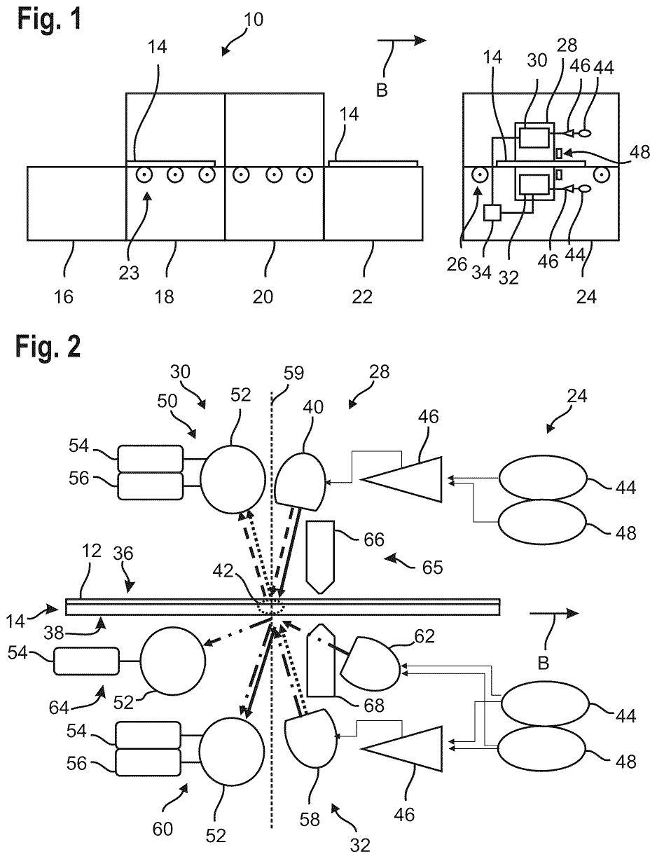

FIG. 1 schematically shows a coating system 10 for applying a substrate coating 12 to an optically transparent substrate 14 (cf. FIG. 2).

The substrate 14 is made of glass or a plastic material, for example, and is essentially plane. For example, the substrate 14 is a plate having a rectangular cross-section and external dimensions of up to 4×9 meters. Basically, however, the type and shape of the substrate 14 is not restricted in any way as long as it is optically transparent and can be handled by the coating system 10.

In the following, the substrate 14 provided with the substrate coating 12 will also be referred to as “coated substrate 14”.

The coating system 10 has a loading module 16, a coating module 18, a washing module 20 and an unloading module 22, which are arranged in succession along a processing direction B.

The loading module 16 serves to load the substrate 14 onto a roller arrangement 23 of the coating system 10, which can be used to move the substrate 14 along the processing direction B.

In the coating module 18, the substrate coating 12 is applied to the substrate 14. The type of substrate coating 12 is not restricted in any way, as long as the coated substrate 14 is also optically transparent. For example, the substrate coating 12 is an anti-reflection coating, a thermal coating, and/or a protective coating.

In the washing module 20, any residues from the coating process in the coating module 18 are removed.

The coated substrate 14 can be removed in the unloading module 22, for example by means of a removal mechanism (not illustrated).

The number and type of modules of the coating system 10 shown in FIG. 1 are merely exemplary, so that further and/or other modules may of course also be provided in the coating system 10.

Furthermore, the coating system 10 has a device 24 for determining optical properties of the optically transparent substrate 14.

As illustrated schematically in FIG. 1, the device 24 is arranged separately in relation to the other modules of the coating system 10 so that the device 24 can be operated independently of these. The device 24 may, of course, also be integrated in the sequential arrangement of the other modules of the coating system 10 along the processing direction B. For example, the device 24 may be arranged between the washing module 20 and the unloading module 22.

The device 24 has a transport device 26, by means of which the substrate 14 can be moved through the device 24 along the processing direction B, for example at a speed of 5 m/min or less.

The device 24 further has a measuring head 28, which includes a first measuring unit 30 and a second measuring unit 32.

The measuring head 28 is connected to a control module 34 for signal transmission, so that the components of the measuring head 28 can be controlled by means of the control module 34 and measurement data collected by the measuring head 28 can be transmitted to and evaluated by the control module 34.

In addition, the control module 34 is configured to control the further components of the device 24.

In FIG. 2, selected components of the device 24 and their arrangement relative to the coated substrate 14 are illustrated in more detail.

As can be seen in FIG. 2, in the embodiment shown, the substrate coating 12 fully covers a first side 36 of the substrate 14, whereas there is no substrate coating on a second side 38, opposite to the first side 36, of the substrate 14.

Of course, the substrate 14 may also be coated differently from the embodiment shown in FIG. 2. For example, the substrate coating 12 may also be applied only in partial areas of the first side 36 of the substrate 14. In addition, the substrate coating 12 may also comprise a plurality of sublayers. Furthermore, a substrate coating 12 may be present on both the first side 36 and the second side 38 of the substrate 14.

The first measuring unit 30 has a first emission unit 40 that is configured to emit directed electromagnetic radiation onto a measuring area 42 of the substrate 14.

For this purpose, the first emission unit 40 is connected to a first source 44 of electromagnetic radiation, with a switching element 46 being arranged between the first source 44 and the first emission unit 40, by means of which the first source 44 can be connected. In other words, the switching element 46 can be used to determine whether electromagnetic radiation from the source 44 reaches the first emission unit 40 and thus whether or not the first emission unit 40 is active. The switching time of the first emission unit 40 is thus fixed through the switching time of the switching element 46.

The switching element 46 is preferably a fiberswitch to allow a particularly fast switchover, and in particular has a switching time of 30 ms or less.

Further provided is a second source 48 of electromagnetic radiation, which can also be connected using the switching element 46.

The first source 44 and the second source 48 preferably make electromagnetic radiation of different wavelengths or wavelength ranges available, so that directed electromagnetic radiation of different wavelengths can be emitted by means of the first emission unit 40, depending on whether the first source 44 and/or the second source 48 is connected by means of the switching element 46.

For example, the first source 44 provides for electromagnetic radiation having a wavelength in the visible range of the light spectrum and the second source 48 provides electromagnetic radiation having a wavelength in the near infrared range of the light spectrum.

The sources 44 and 48 are, for example, LEDs and/or halogen lamps.

In principle, rather than a plurality of sources 44 and 48, only a single source of electromagnetic radiation may be provided if this source alone can make electromagnetic radiation of the desired wavelength range available.

It should be appreciated that the switching element 46 is adapted to the respectively used type and number of sources 44 and 48. Accordingly, the switching element 46 may have one or more connection points for the sources 44 and 48 and one or more outputs, which is or are connected to the respectively assigned emission unit. In the embodiment illustrated in FIGS. 2 to 4, a variant is shown in which the switching elements 46 each have a plurality of connection points and a single output.

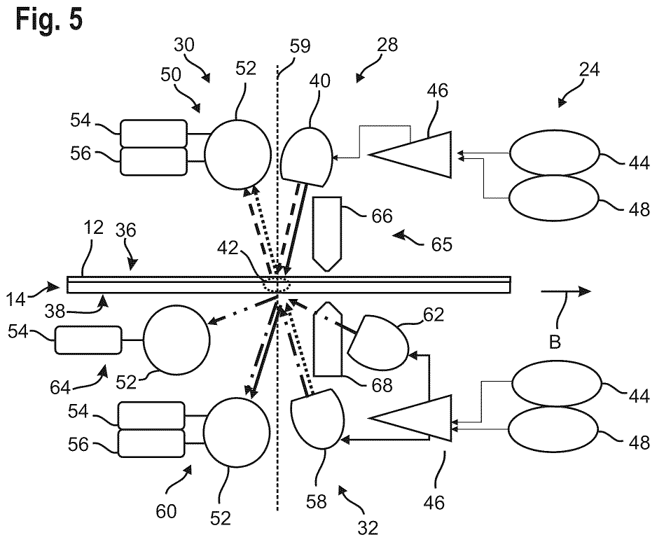

FIG. 5 shows a further variant in which the switching element 46 assigned to the first emission unit 40 has a plurality of connection points and a single output, whereas the switching element 46 assigned to the second emission unit 58 has a plurality of connection points and a plurality of outputs.

The measuring area 42 has a length of 30 mm or less, the length describing the extent of the measuring area 42 along the direction in which the measuring area 42 is largest. In the variant shown in FIG. 2, this is the extent parallel to the processing direction B.

The first measuring unit 30 further has a first detector unit 50, which comprises a sensor element 52 (illustrated only schematically here), a VIS spectrometer 54 and a NIR spectrometer 56.

The sensor element 52 is fundamentally configured to detect electromagnetic radiation impinging on the sensor element 52, wherein an intensity distribution can be determined as a function of the wavelength of the impinging electromagnetic radiation. Based on this measurement data, an evaluation can be performed in the VIS spectrometer 54 (for the visible range of the light spectrum) and/or in the NIR spectrometer 56 (for the near infrared range of the light spectrum), which allows conclusions to be drawn about the optical properties of the coated substrate 14.

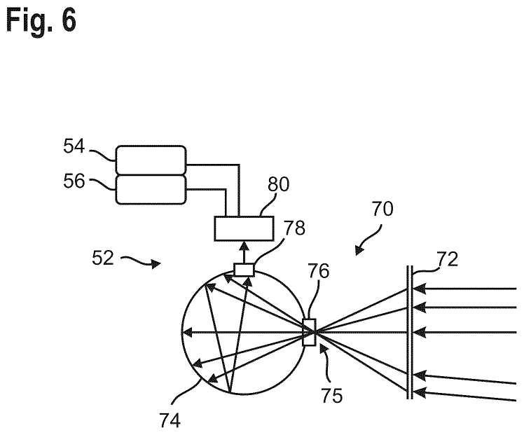

In an optional design, the sensor element 52 may comprise a homogenization device 70. FIG. 6 schematically illustrates an exemplary structure of the homogenization device 70.

The homogenization device 70 has a collector 72 and a homogenizer 74.

When electromagnetic radiation (indicated by arrows) impinges on the collector 72, the incident rays are focused on a focal point 75 of the collector 72. An inlet opening 76 of the homogenizer 74, which is in the form of an integrating sphere, for example, is arranged at the focal point 75. The electromagnetic radiation that has entered the homogenizer 74 through the inlet opening 76 can leave the homogenizer 74 again through an outlet opening 78 and be directed to a sensor 80, which detects the electromagnetic radiation.

FIG. 6 shows, by way of example, a path toward the outlet opening 78 for one of the rays entering the homogenizer 74 through the inlet opening 76. It should be appreciated that the actual path depends on the angle of incidence and the design of the inside of the homogenizer 74.

Such an embodiment makes it possible in particular for the sensor 80 to be structurally separated from the homogenization device 70 used for collimation of the incident electromagnetic radiation. This further simplifies the setup.

In addition, interference due to scattered light can be further minimized.

Accordingly, the VIS spectrometer 54 and the NIR spectrometer 56 are connected to the sensor 80, which detects the electromagnetic radiation that has exited through the exit opening 78 and has been homogenized.

The second measuring unit 32-by analogy with the first measuring unit 30 has a second emission unit 58, which is configured to emit directed electromagnetic radiation onto the same measuring area 42 of the substrate 14 that can also be irradiated by the first measuring unit 30. The second emission unit 58, however, irradiates the measuring area 42 from the second side 38 of the substrate 14.

The second emission unit 58 is also connected to a first source 44 and a second source 48 of electromagnetic radiation by means of a switching element 46 of the second measuring unit 32.

Likewise, the second emission unit 58 has a second detector unit 60, which also comprises a sensor element 52 (illustrated only schematically in FIG. 2), a VIS spectrometer 54 and a NIR spectrometer 56, analogous to the first detector unit 50.

By analogy with the first detector unit 50, the second detector unit 60 may also comprise a homogenization device 70, as is shown in FIG. 6.

The first emission unit 40 and the second emission unit 58 are oriented in relation to the coated substrate 14 such that the electromagnetic radiation emitted by the first emission unit 40 and the second emission unit 58 impinges at a first emission angle α₁ and, respectively, a second emission angle α₂ relative to the normal 59 of the first side 36 and, respectively, the second side 38 of the substrate 14.

According to the invention, the first emission angle α₁ and the second emission angle α₂ are not equal to 0° and are in particular in the range from 3 to 10°, for example they are 8°.

The second measuring unit 32 further has a third emission unit 62, which is also configured to irradiate the same measuring area 42 with electromagnetic radiation as the first emission unit 40 and the second emission unit 58. To this end, the third emission unit 62 is likewise connected to the first source 44 and the second source 48, like the second emission unit 58.

As can be seen in FIG. 2, the third emission unit 62 is not connected to the first source 44 and the second source 48 by means of the switching element 46 of the second measuring unit 32. However, the third emission unit 62 may, of course, also have an analog switching element 46.

It is also possible for the switching element 46 to have a plurality of outputs as described above, with one of the outputs being connected to the third emission unit 62. Such a further embodiment is illustrated in FIG. 5, wherein the further embodiment otherwise corresponds to the embodiment according to FIGS. 2 to 4, so that the discussions relating to this embodiment also apply analogously to the embodiment according to FIG. 5.

The second measuring unit 32 further includes a third detector unit 64 that is assigned to the third emission unit 62 and comprises a sensor element 52 and a VIS spectrometer 54.

The electromagnetic radiation emitted by the third emission unit 62 impinges on the second side 38 of the substrate 14 at a third emission angle α₃ relative to the normal 59, wherein the third emission angle α₃ is significantly greater than the first emission angle α₁ and the second emission angle α₂. For example, the third emission angle α₃ is in the range of 45 to 65°.

By analogy with the first detector unit 50 and the second detector unit 60, the third detector unit 64 may also comprise a homogenization device 70, as is shown in FIG. 6.

The device 24 further comprises a unit 65 for carrying out a measurement of a sheet resistance of the coated substrate 14, namely a unit for carrying out an eddy current measurement. The unit 65 comprises two measuring probes 66 and 68, wherein the measuring probe 66 is assigned to the first side 36 of the coated substrate 14 and the measuring probe 68 is assigned to the second side 38 of the coated substrate 14.

The unit 65 allows properties of the coated substrate 14 to be determined based on the induction of currents in the coated substrate 14 and thus provides the possibility of determining the properties of the coated substrate 14 by means of a method that is complementary to optical measuring methods.

In doing so, the unit 65 examines the same measuring area 42 that was also irradiated by the emission units 40, 58 and 62, for example after the substrate 14 has been moved along the processing direction B up to the level of the measuring probes 66 and 68.

The control of the unit 65, which is coordinated with the further measurements, can be ensured by means of the control module 34, which is also connected to the unit 65 for signal transmission and controls it.

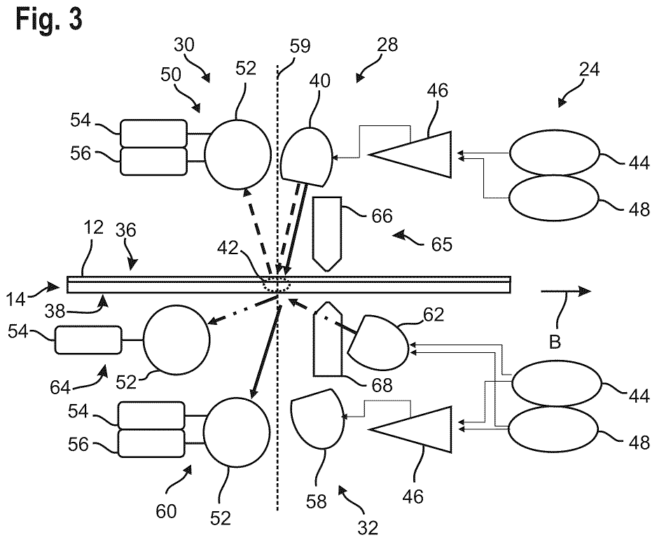

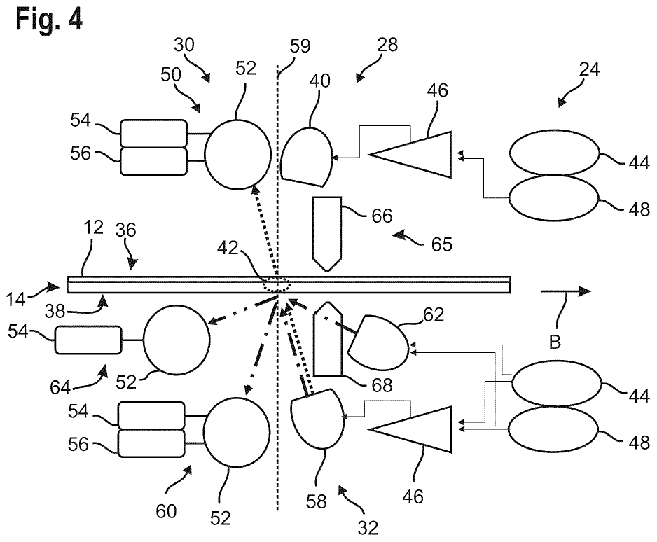

The operating principle of the device 24 according to the invention will now be further discussed below with reference to FIGS. 3 and 4.

According to the invention, the device 24 has a first operating mode (cf. FIG. 3) and a second operating mode (cf. FIG. 4). The first operating mode and the second operating mode differ in terms of which of the emission units 40 and 58 are active.

In the first operating mode, the first emission unit 40 is active and the second emission unit 58 is inactive (cf. FIG. 3). In other words, in the first operating mode, the connection between the first emission unit 40 and the sources 44 and 48 of the first measuring unit 30 is enabled by means of the switching element 46 of the first measuring unit 30, while the connection between the second emission unit 58 and the sources 44 and 48 of the second measuring unit 30 is blocked by means of the switching element 46 of the second measuring unit 30.

Therefore, in the first operating mode, the measuring area 42 is irradiated with electromagnetic radiation only by the first emission unit 40. The electromagnetic radiation impinging on the coated substrate 14 partially passes through the coated substrate 14 and is partially reflected by the coated substrate 14, namely by the substrate coating 12, resulting in a transmission beam path (indicated by arrows in the figures) and a reflection beam path (indicated by dashed arrows in the figures).

The electromagnetic radiation of the transmission beam path impinges on the sensor element 52 of the second detector unit 60, while the electromagnetic radiation of the reflection beam path impinges on the sensor element 52 of the first detector unit 50. In this way, according to the invention, the transmission and reflection properties of the coated substrate 14 are examined at the same time in the first operating mode when irradiated from the first side 36.

In the second operating mode, the second emission unit 58 is active and the first emission unit 40 is inactive (cf. FIG. 4). In other words, in the second operating mode, the connection between the second emission unit 58 and the sources 44 and 48 of the second measuring unit 32 is enabled by means of the switching element 46 of the second measuring unit 32, while the connection between the first emission unit 40 and the sources 44 and 48 of the first measuring unit 30 is blocked by means of the switching element 46 of the first measuring unit 30.

In the second operating mode, the measuring area 42 is therefore irradiated with electromagnetic radiation by the second emission unit 58. The electromagnetic radiation impinging on the coated substrate 14 partially passes through the coated substrate 14 and is partially reflected by the coated substrate 14, again resulting in a transmission beam path (indicated by dotted arrows in the figures) and a reflection beam path (indicated by dash-dotted arrows in the figures).

The electromagnetic radiation of the transmission beam path impinges on the sensor element 52 of the first detector unit 50, while the electromagnetic radiation of the reflection beam path impinges on the sensor element 52 of the second detector unit 60. Thus, according to the invention, the transmission and reflection properties of the coated substrate 14 are examined at the same time in the second operating mode when irradiated from the second side 38.

In addition, in the embodiment shown, the third emission unit 62 is active both in the first operating mode and in the second operating mode, so that the measuring area 42 is additionally irradiated with electromagnetic radiation by the third emission unit 62. This radiation is reflected by the second side 38 of the substrate 14 and impinges on the sensor element 52 of the third detection unit 64 (illustrated in the figures by dashed-double-dotted arrows). The third detection unit 64 can be used to determine the color impression given to an observer of the substrate 14 when the observer looks at the second side 38 of the substrate at a viewing angle that corresponds to the third emission angle.

Basically, it is also possible for the third emission unit 62 to be active only in the first operating mode or only in the second operating mode. To this end, a separate switching element 46 may be assigned to the third emission unit 62 as described above, so that the sources 44 and 48 themselves still do not have to be switched on and off.

In addition, it is possible to use the third detector unit 64 to determine any scattered light components that occur in the second operating mode during operation of the second emission unit 58, in particular if in the second operating mode the third emission unit 62 is not operated. In this way, scattered light components can be taken into account in the evaluation of the measurements in the second operating mode. This also applies accordingly to the first operating mode if the first side 36 of the coated substrate 14 has a third detector unit 64 assigned to it.

The change between the first operating mode and the second operating mode may take place very quickly and is only limited by the switching time of the switching elements 46. Moreover, the device 24 according to the invention distinguishes itself in that the total measurement time for determining optical properties of the substrate 14 is greatly reduced, since the number of individual measurements to be carried out is minimized as a result of the simultaneous determination of transmission and reflection properties of the coated substrate 14 (from the first side 36 in the first operating mode and from the second side 38 in the second operating mode). In this way, in addition, a comparatively small measuring area 42 can be achieved in which all measurements are carried out, so that the optical properties of the coated substrate 14 can be determined with a high local resolution.

The measuring head 28 as a whole, the first measuring unit 30, the second measuring unit 32 and/or the unit 65 for performing a measurement of a sheet resistance of the substrate 14 are preferably movable along the substrate 14. In this way, on the one hand, different areas of the substrate 14 can be examined and, on the other hand, the movements of the substrate 14 can be compensated along the processing direction B in order to minimize the size of the measuring area 42 and/or to ensure that the same measuring area 42 is examined in the different operating modes as well as by the unit 65. In particular, a multiple measurement may also be implemented.

All in all, the device 24 according to the invention distinguishes itself by a high degree of flexibility in determining optical properties of the coated substrate 14 and by making it possible to realize particularly small measuring areas.

### LIST OF REFERENCE NUMBERS

10 coating system
12 substrate coating
14 substrate
16 loading module
18 coating module
20 washing module
22 unloading module
23 roller arrangement
24 device for determining optical properties
26 transport device
28 measuring head
30 first measuring unit
32 second measuring unit
34 control module
36 first side of the substrate
38 second side of the substrate
40 first emission unit
42 measuring area
44 first source
46 switching element
48 second source
50 first detector unit
52 sensor element
54 VIS spectrometer
56 NIR spectrometer
58 second emission unit
59 normal
60 second detector unit
62 third emission unit
64 third detector unit
65 unit for performing a measurement of the sheet resistance
66 measuring probe
68 measuring probe
70 homogenization device
72 collector
74 homogenizer
75 focal point
76 inlet opening
78 outlet opening
80 sensor

1. A device for determining optical properties of an optically transparent substrate which is provided with a substrate coating on a first side,
wherein the device comprises a first measuring unit and a second measuring unit, the first measuring unit being assigned to the first side of the substrate and the second measuring unit being assigned to a second side of the substrate opposite to the first side,
wherein the first measuring unit comprises a first emission unit for irradiating a measuring area of the substrate with directed electromagnetic radiation and a first detector unit
wherein the second measuring unit comprises at least a second emission unit for irradiating the measuring area of the substrate with directed electromagnetic radiation and at least a second detector unit,
wherein the device has a first operating mode and a second operating mode, wherein, in the first operating mode, the first emission unit is active and the second emission unit is inactive and, in the second operating mode, the first emission unit is inactive and the second emission unit is active, so that
in the first operating mode, the electromagnetic radiation reflected by the substrate coating in the measuring area can be detected in the first detector unit and the electromagnetic radiation transmitted by the substrate in the measuring area can be detected in the second detector unit, and
in the second operating mode, the electromagnetic radiation reflected by the substrate in the measuring area can be detected in the second detector unit.

2. The device according to claim 1, wherein at least one of the first emission unit and the second emission unit is arranged in relation to the first side and, respectively, to the second side of the substrate such that the electromagnetic radiation emitted has a first and, respectively, a second emission angle in the range of 3 to 10° relative to the normal of the first side and, respectively, the second side of the substrate.

3. The device according to claim 1, wherein the substrate, the first emission unit the second emission unit, the first detector unit and the second detector unit are arranged in relation to each other such that a first connecting line extending from the first emission unit toward the second detector unit intersects a second connecting line in the measuring area of the substrate extending from the second emission unit toward the first detector unit.

4. The device according to claim 1, wherein at least one of the first detector unit and the second detector unit comprises at least one of a VIS spectrometer and a NIR spectrometer.

5. The device according to claim 1, wherein at least one of the first emission unit and the second emission unit is assigned a switching element by means of which a source electromagnetic radiation can be connected in order to actively switch one of the first emission unit and the second emission unit, in particular wherein the switching element is integrated in the respective emission unit.

6. The device according to claim 5, wherein the switching element has a switching time of 30 ms or less.

7. The device according to claim 1, wherein the measuring area has a length of 30 mm or less.

8. The device according to claim 1, wherein at least one of the first measuring unit and the second measuring unit has a third emission unit for irradiating the measuring area of the substrate with directed electromagnetic radiation and a third detector unit assigned to the third emission unit, wherein the third emission unit is arranged in relation to at least one of the first side and the second side of the substrate such that the electromagnetic radiation emitted has a third emission angle relative to the normal of the first side and, respectively, the second side of the substrate, in particular wherein the third emission angle is in the range of 45 to 65°.

9. The device according to claim 8, wherein the third emission angle is adjustable in steps or continuously.

10. The device according to claim 1, wherein the electromagnetic radiation has a wavelength in the range from 350 to 2500 nm.

11. The device according to claim 1, wherein at least one measuring head is provided which includes at least one of the first measuring unit and the second measuring unit, and wherein the measuring head is movable along the substrate.

12. The device according to claim 1, wherein the device has a transport device by means of which the substrate can be moved along a processing direction.

13. The device according to claim 1, wherein the device is configured to determine the optical properties of the substrate in a plurality of measuring areas, wherein for each of the measuring areas at least one measurement is performed in the first operating mode of the device and one measurement is performed in the second operating mode of the device

14. The device according to claim 1, wherein the device includes a unit for performing a measurement of a sheet resistance of the substrate in particular for performing an eddy current measurement in the measuring area of the substrate.

15. A coating system for manufacturing an optically transparent substrate having a substrate coating applied to a first side of the substrate, comprising a device for determining optical properties of the optically transparent substrate according to claim
